(19) United States
(12) Patent Application Publication
(10) Pub. No.: US 2004/0230338 A1
(43) Pub. Date: Nov. 18, 2004

(54) Token and container dispensing apparatus

(76) Inventor: Kenichi Tezuka, Tokyo (JP)

Correspondence Address: SNELL & WILMER LLP, 1920 MAIN STREET, SUITE 1200, IRVINE, CA, 92614-7230, US

(21) Appl. No.: 10/782,304

(22) Filed: Feb. 19, 2004

(30) Foreign Application Priority Data
Feb. 20, 2003 (JP) 2003-042470

(51) Int. Cl. G07F 7/00

(52) U.S. Cl. 700/231

(57) ABSTRACT

A token and container dispensing device stores containers which can be dispensed to receive a predetermined number of tokens. A user can deposit a certain value and select the appropriate number of tokens. A token dispensing unit can dispense the tokens to a container located at a dispensing section. Both the location of the container and the number of tokens can be monitored and determined to thereby prevent any overflow of tokens. A control unit can automatically control the operation and position an appropriate container to receive a predetermined number of tokens. A second container can also be automatically dispensed if the desired tokens are greater than the storage capacity of the initial container.

### BACKGROUND OF THE INVENTION

1. Field of the Invention

The present invention is directed to a combination token and container dispensing apparatus for dispensing a plurality of stored tokens and, more particularly, to monitoring and dispensing both containers to hold the tokens and the total amount of tokens to be dispensed.

2. Description of Related Art

Various forms of token dispensing apparatus have been known, and in this regard, the terminology “token” is generically used to include coins, medallions, and other objects representative of a monetary value that can be exchanged for services, products or money such as found in videogame arcades, gaming establishments, casinos, pachinko parlors, and the such. The prior art is aware of various configurations of token dispensing units including storage hoppers, bowls and other storage members that can operatively interact with a selector unit for releasing a token from the storage member for dispensing to the user.

Also containers have been used to receive the tokens, and an example of a container dispensing unit for dispensing a container to receive such tokens can be found in Japanese Patent No. 2860818.

When dealing with a large number of tokens, for example, in a videogame arcade, tokens can be dispensed in response to different denominations. For example, in response to a certain value received from the user, a large number of tokens such as 350 tokens can be dispensed and used in the arcade games. If the number of tokens to be dispensed, however, is greater than the storage capacity of a container, it is possible that the tokens will overflow the container, and the customer will have to be careful to prevent any spillage from a container and to reinsert another container.

Thus, there is a demand in the industry for not only supplying containers appropriate for the particular form of token, but also to monitor and control the filling of the container and any subsequent containers.

### SUMMARY OF THE INVENTION

The present invention is directed to a token dispensing apparatus including a token dispensing unit that can store tokens to be dispensed to a user. The tokens can be dispensed in response to a value being inputted by the user such as money or credit cards which then would enable a token selector unit to release a desired number of tokens from a storage member to the user.

A container dispensing unit can dispense containers to an appropriate location to receive the tokens and can include a container storage unit and a container separating unit for releasing a container from the storage member to the desired position.

A monitoring system can sense both the tokens as they are released and the location of containers for receiving the tokens and includes a first sensor unit for sensing the number of tokens released and a second sensor unit for sensing a container at a position to receive the released tokens. A control unit which can include a microprocessor base system can enable the operation of the token dispensing apparatus including the determination of the appropriate number of tokens to be released in response to value inputted by the user. The control unit can receive an output from the first sensor unit and can compare it with a predetermined value representative of a desired capacity of the container that will hold the tokens. The control unit can prevent the release of the tokens until the second sensor unit determines the existence of a container at the release position and after receiving such a signal, can enable the token selector unit to release tokens. Based on the output of the first sensor unit that senses the number of tokens released, the control unit can stop the dispensing of the tokens when the predetermined value representative of the desired capacity of the container is reached and can further compare the predetermined value with the total number of tokens requested or authorized to be released. When the total number of tokens are greater than the predetermined value of tokens that can be held by a single container and the second sensor unit indicates that the initial container has been removed, the control unit can automatically activate a container separating unit to release the second container, and upon the second sensor unit's sensing the second container, the control unit can then reactive the token selector unit to continue to release tokens under the monitoring of the control unit.

In addition, the token dispensing apparatus can also have a display unit or other indicator that can advise the user with appropriate characters or indicia to remove the first container and to inform the user that a second container is required to hold additional tokens.

As a result of the present invention, an automatic and convenient manner of both dispensing and storing a plurality of tokens in a container to a user is provided in a relatively economical manner.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings.

FIG. 1 is a schematic of a token dispensing apparatus, of one embodiment of the present invention.

FIG. 2 is a schematic block diagram of the control system.

FIG. 3 is a flow chart for describing the operation of the preferred embodiment.

### DETAILED DESCRIPTION OF THE PREFERRED EMBODIMENTS

Reference will now be made in detail to the preferred embodiments of the invention which set forth the best modes contemplated to carry out the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

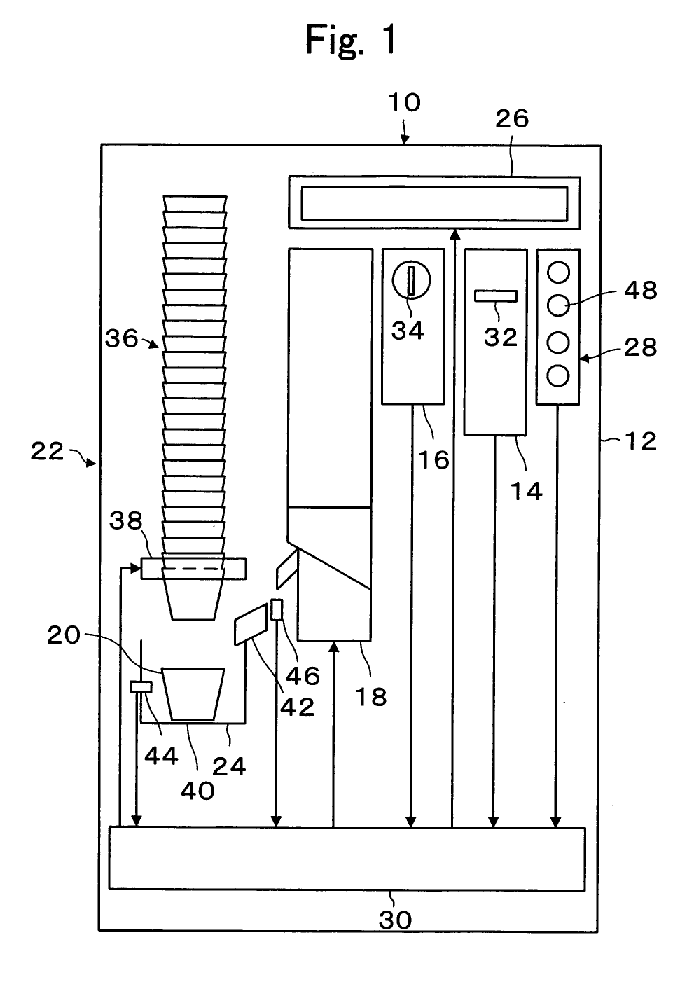

Referring to FIG. 1, a token and container dispensing apparatus is schematically shown and can be mounted within a boxlike exterior chassis 12 that can have an appropriate user interface including a display, operator controls and slots for receiving coins, monetary bills, and even credit cards. Schematically shown is a bill note acceptor 14 for receiving monetary bank notes and, as is well known in the prior art, such banknotes can be examined to determine their authenticity. A coin selector 16 can be utilized for distinguishing tokens.

A displaying unit 26 can be provided on an exterior of the housing 12 to provide information to the user.

Within the housing can be a token dispensing unit 18 which can include a storage member for storing tokens and a token selector unit for releasing a token from the storage member based, for example, on a user request. The specific configurations of the hopper or storage unit and the token selector unit also are known by people skilled in this field, and accordingly, the specific details have been omitted.

A container dispensing unit 22 for dispensing individual containers from a container storing section 36 is also schematically disclosed. A container separating section unit 38 has the capacity of separating the lowermost container 20 and dropping it to a token dispensing section or platform 24. When the tokens are dispensed, they enter into a chute 42 and slide down so they are deposited within the container 20 at the dispensing section 24.

Alternatively, the tokens can be arranged to simply drop directly into the container 20. As the coins are entering into the chute 42, they are detected by a first sensor unit or amount detecting unit 46 which has the function of detecting the amount of coins directly deposited into the container 20 at the dispensing section 24.

A second sensor unit or container detecting unit 24 is attached at a sidewall above the platform or dispensing section 24 and is capable of detecting the presence of a container 20 at the dispensing section 24. As can be determined from the schematic control lines with arrowheads in FIG. 1, a control unit 30 is also mounted within the chassis 12 and can, for example, be a microprocessor-based control system to coordinate and activate the various individual components that make up the operating system for the token dispensing apparatus and container dispensing unit.

In operation, the user can insert an instrument of some value such as a credit card, banknote, coins, and the control unit 30 can cooperate in enabling the verification and authentication of the value entered before activating the release of any tokens. As can be seen, a user control panel 28 with various buttons 48, such as a keypad or other controls, can be provided for the user to make a selection as to the number of tokens that are being requested.

When a bill is inserted through the slot 32, the control unit 30 can monitor whether the bill is genuine, and if so, output a denomination signal and store the note in an appropriate storing section. If a banknote is indicated as false, it can be returned.

Likewise, the coin selector unit 16 can receive a coin through the slot 34 and also can determine whether the coin is genuine, and if so, output a denomination signal to the control unit 30 while storing the coin in an appropriate storing section. Again, if the coin is fake, it can be returned. A currency receiving unit can be used as a reading and writing unit for a magnetic card or a smart card, and it is possible to combine inputs from each of these units to permit the user to select an appropriate value from which the tokens can be determined. In operation, the token dispensing unit 18 can dispense tokens on a one-by-one basis as a result of dispensing signals generated by the control unit 30. The token dispensing unit 18 can be a coin hopper such as disclosed in Japanese Utility Model No. 2538531, although other hoppers or storage units can be utilized within the parameters of the present invention.

Referring to the container dispensing unit 22, it has a function to automatically dispense a container 20 which can be in a bucket or cuplike shape. The container 20 has the capacities of storing a predetermined number of tokens that are received on a one-by-one basis from dispensing signals generated by the control unit 30. The individual containers 20 can be stacked in the container storing section 36 and can be selectively dispensed by the container separating section unit 38 to drop a container onto the dispensing section 24. The container separating section 38 can, for example, be of the type disclosed in the Japanese Patent No. 2860818, although other forms of dispensing containers can be utilized.

The container detecting unit 44 can generate a signal indicating the location of a container 20 in the receiving box 40. Tokens can be selectively released from the token dispensing unit 18 and appropriately sensed by the token amount detecting unit 46 as they slide through the chute 42 for entrance into the container 20. As can be appreciated, the sensing unit for both the tokens and the sensing unit for the container can take various configurations. The container detecting unit 44 can, for example, use either a photoelectric sensor, a mechanical sensor or an acoustical sensor. The amount detecting unit 46 can be of an indirect type which actually counts a dispensing signal which is output by a photoelectric sensor that is interrupted by the coins as they travel through the chute 42 from the token dispensing unit 18. The amount detecting unit 46 or first sensor unit can, for example, be an optical type, electrical type or even a supersonic type of detector which can directly detect the movement of the tokens to the container 20.

The displaying unit 26 has a function of informing the user with an appropriate indicia message that can be provided on a matrix display, for example, a liquid crystal display, cathode ray tube, fluorescence character display or even a plasma panel display. The user interface 28 or operating board can have a function that, when a currency is submitted for tokens, it will start the appropriate program upon activation of the buttons 48. The operator board 28, however, can be changed, for example, to a touch screen.

The control unit 30 will receive signals from the appropriate banknote acceptor 14, coin selector 16, operating board 28, container detecting unit 44, and the amount detecting unit 46. The control unit 30 can be programmed to perform an arithmetic operation or activate an algorithm in a computer program to permit an automatic predetermined operation. The control unit 30 can subsequently control the token dispensing unit 18, the container dispensing unit 22, and the displaying unit 26.

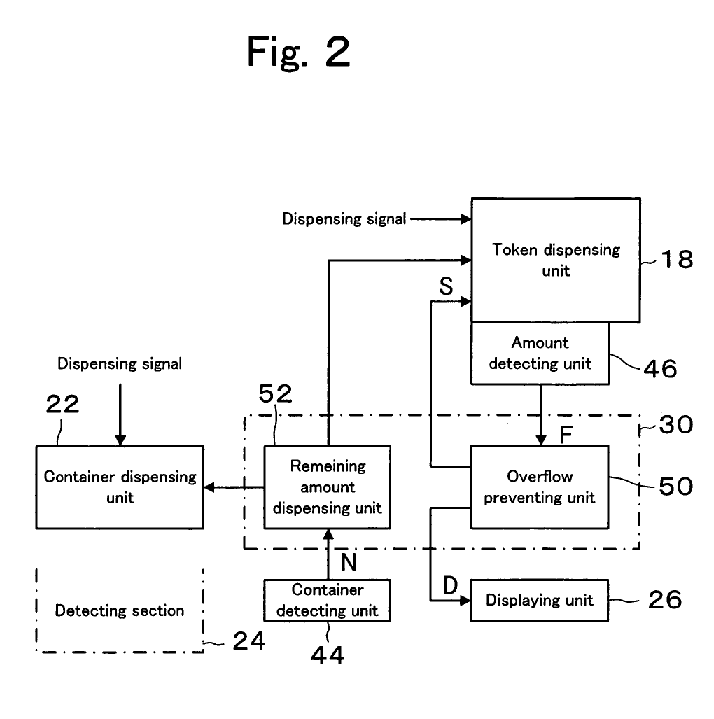

Referring to FIG. 2, the control unit 30 includes at least an overflow preventing unit 50 and a remaining amount dispensing unit 52. These functions can be provided by software modules that can be appropriately updated to accommodate different types of tokens and currency values.

The overflow preventing unit 50 receives the inputs from the amount detecting unit or first sensor unit 46 and the container detecting unit or second sensor unit 44 in providing a dispensing stopping signal S to the token dispensing unit 18 based on a determination of a full signal F from the amount detecting unit 46. The token dispensing unit 18 is accordingly controlled to prevent any overflow of tokens. Additionally, the overflow preventing unit 50 can generate a display signal D to the displaying unit 26 to indicate to the user to remove the container 20 which is now full of tokens.

When the remaining amount dispensing unit 52 receives an output from the container detecting unit 44, indicating that no container is currently located on the platform 24 or in the box 40, it can then activate the separating section unit 38 in the container dispensing unit 22 so that a single container 20 will be dispensed to the dispensing section 24. This enables the token dispensing unit 18 to start, and any remaining tokens can then be dispensed into the second container 20 at the dispensing section 24.

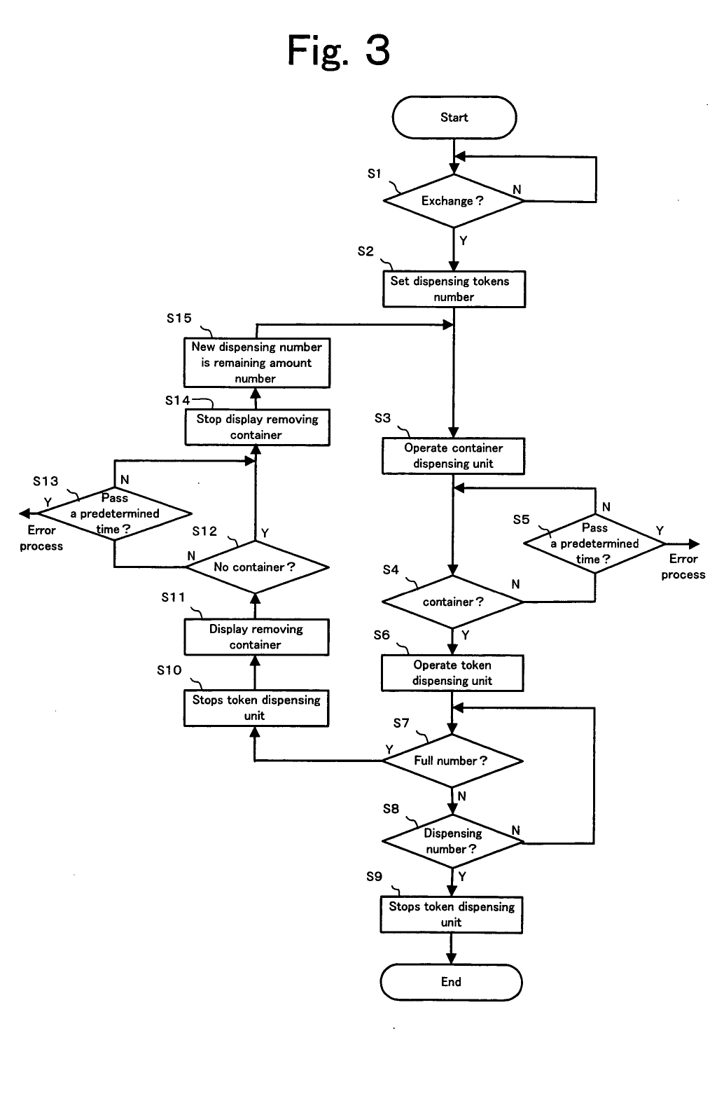

Referring to FIG. 3, a flow chart setting forth an algorithm of operation of the token and container dispensing apparatus is disclosed. Upon an initialization from a user at the start, a desired number of tokens are set based on the currency or value inserted by the user. This operation can be performed by software in the controlling unit 30. For example, if 100 tokens are available for a 1,000 Yen bill, 200 tokens for a 2,000 Yen bill, and 350 tokens for a 3,000 Yen bill, and 800 tokens for a 5,000 Yen bill, this can be displayed to the user, and the appropriate selections from the operating board 28 can be implemented. The controlling unit 30 has already been programmed to determine the predetermined number of tokens that are appropriate to be held within the particular size of container 20, for example, 300 tokens.

Before there is any exchange or release of tokens, the currency or value entered by the user, for example, through a credit card entry (not shown), a banknote acceptor 14 and/or a coin selector 16 is displayed on the displaying unit 26. The user then can operate the currency determining buttons 48 to decide the amount of tokens to be exchanged. If the receiving currency or value is more than the exchange in currency, the difference in currency can be returned to the user through a change slot (not shown).

At Step S1, currency determining buttons 48 are operated, and an exchange signal is distinguished by the control unit 30. If the buttons are not operated, the program loops back to the start position. At Step S2, if the buttons 48 are activated for 1,000 Yen, then the dispensing amount of tokens is set to 100 tokens by the control unit 30. In Step S3, the container dispensing unit 22 is operated so that the container separating unit 38 releases a container 20 to the platform 24 from the container storing section unit 36. Only the lowest container 20 will be released, and it will be guided to a predetermined position at the dispensing section 24 by a guiding unit (not shown).

The program then advances to Step S4, and a container detecting signal from the container detecting unit or second sensor unit 44 is determined. If there is no container, the program goes to Step S5 and continues to loop for a predetermined number of times or time period if a container is not released. After the predetermined time period, an error signal will be generated, indicating either that the containers have been exhausted or are jammed. As a result, the program is stopped and remains in a suspended state, and an error can be displayed to the user on the displaying unit 26.

When it is determined that a container 20 does exist at Step S4, the program proceeds to Step S6, and the token dispensing unit 18 is enabled to operate so that tokens are sequentially dispensed one at a time through the token chute 42 and are monitored by the amount detecting unit or first sensor unit 46. The tokens will slide down the chute into the container 20 at the dispensing section 24. The number of tokens released are counted by the controlling unit 30, and this value is used to determine the number of tokens stored within the container 20.

At Step S7, an accumulated counting number is compared to a stored full load number which has been predetermined based on the particular size of containers 20 utilized. For example, if the container 20 can hold a total of 300 tokens, the program will proceed to Step S8, and the dispensing of the tokens continues. When the actual number of tokens have been added up to 100, the program goes to Step S9, and the token dispensing unit 18 will stop, and the token dispensing processing is thereby finished. A signal can be displayed on the displaying unit 26 indicating a completion of the dispensing of tokens.

If the user desires to have 350 tokens by inserting a 3,000 Yen note, the appropriate buttons are pushed in the panel 48, and at Step S2, the dispensing amount is set to 300 tokens. The counting number of the amount detecting unit 46 would thereby reach the predetermined number 300 tokens which is the fill amount for a container 20. The overflow preventing unit 50 will output a dispensing stopping signal S, and a removal single D to the display unit 26. The program would then advance, for example, from Step S7 to Step S10. At Step S10, the token dispensing unit will receive a dispensing stopping signal S, and the dispensing of the tokens will be stopped. At Step S11, the display 26 will be provided with a message to urge the user to remove the filled container 20 from the dispensing section 24 based on the removal signal D. The removing display 26 can be further supplemented by an audible or recorded voice information.

As an alternative embodiment, the container 20 can be automatically removed from the dispensing section 24 to a wait station by an automatic taking off unit (not shown). The automatic taking off unit will translate the container 20 that is now full of tokens in a manner that will remove it from the fill station on the platform 24 without spilling coins from the loaded container 20.

When the filled container 20 is removed from the platform 24, the container detecting unit 44 will indicate that the loading station can receive another container, and the control unit 30 will activate the container separating unit 38 to permit another container to be removed from the container storage unit 36. Control unit 30 can then reactivate the token dispensing unit 18 to continue the dispensing of tokens down the token chute 42. These counted tokens will be subtracted from the total number of tokens by a comparison of the count value with the set number of tokens that have been entered by the user. Thus, at Step S12, the introduction of the second container 20 is determined by the signal of the container detecting unit 44. If a no container signal N is outputted by the container detecting unit 44, then at Step S13, a predetermined time period is counted, and if a container has not been introduced within that time period, an error signal is generated. If the container has been produced, then in effect there is a container at the platform 24, and the program will then advance to Step S14, and if no container signal N indicating that no container is available, then the display 26 can then disclose an error message.

As the program proceeds to Step S15, the dispensed number of 300 tokens from the original container is decreased from the user set dispensing number of 350 tokens. Therefore, a new dispensing number for the second container is set to be 50, and the program will then return to Step S3 so that the container dispensing unit 22 is enabled to operate, and a new container is dispensed to the dispensing section 24. Next the program will then advance to Step S4, and a new second container 20 will be detected if it exists at the platform station 24. When the second container 20 is determined, the token dispensing unit 18 will dispense the remaining 50 tokens at Step S6. At Step S8, when the 50 tokens are dispensed, the program goes to Step S9 and the token dispensing unit stops, and the dispensing processing finishes. An appropriate signal can then be provided to the user to remove the container and will confirm that the total number of tokens have now been dispensed.

If the user inserts a 5,000 Yen value in the operating board 28, then three containers will have to be utilized, and the program will thus advance to the process of filling a first container with 300 tokens, a second container with 300 tokens, and a final third container with 200 tokens to reach the required amount of 800 tokens.

As an alternative embodiment, the program and its functioning can be replaced by logic circuitry, and it should be understood that the present invention can be enabled through both software and/or hardware embodiments as known in this art. For example, if the amount detecting unit 46 is set as a counter for tokens which are dispensed from the token dispensing unit 18, the full amount of tokens to be dispensed can be set digitally, and therefore the amount for dispensing tokens can be the same every time, and the process of taking off the container can be minimized.

Those skilled in the art will appreciate that various adaptations and modifications of the just-described preferred embodiment can be configured without departing from the scope and spirit of the invention. Therefore, it is to be understood that, within the scope of the amended claims, the invention may be practiced other than as specifically described herein.

What is claimed is:

1. A token dispensing apparatus comprising:
a token dispensing unit including a storage member for storing tokens;
a token selector unit for releasing a token from the storage member based on a user request;
a container dispensing unit for dispensing a container to receive the tokens including a container storage unit and a container separating unit for releasing a container from the storage member to a position to receive a released token;
a first sensor unit for sensing the number of tokens released;
a second sensor unit for sensing a container at the position to receive a released token;
a control unit for receiving an output from the first sensor unit and comparing it with a predetermined value representative of a desired capacity of the container to hold tokens and receiving an output from the second sensor unit to determine the existence of a container at the position to receive a released token to enable the token selector unit to release tokens, the control unit stops the dispensing of the tokens when a predetermined value representative of the desired capacity is reached and compares the predetermined value with the total number of tokens requested, when the total number tokens are greater than the predetermined value and the second sensor unit indicates the initial container is removed from the position to received released tokens, the control unit automatically activates the container separating unit to release a second container and the second sensor unit senses the second container, the control unit activates the token selector unit to continue to release tokens under the monitoring of the control unit.

2. The token dispensing apparatus of claim 1 further including operator control unit for inputting an amount of tokens to be dispensed and a displaying unit for displaying the status of tokens in the container.

3. The token dispensing apparatus of claim 2 further including a coin receiving unit and a banknote receiving unit for inputting monetary value in return for the amount of tokens to be dispensed.

4. A token dispensing device comprising:
a container dispensing unit which dispenses a container for receiving tokens to a dispensing section based on a dispensing signal;
a token dispensing unit which dispenses the tokens to the container located at the dispensing section;
an amount detecting unit which detects the amount of stored tokens in the container;
an overflow preventing unit which outputs a removing signal for removing the container which is located at the dispensing section and a stopping signal for the dispensing unit, when the amount detecting unit detects a predetermined amount of tokens in the container;
a container detecting unit which detects the container located at the dispensing section; and
a remaining amount dispensing unit which enables the token dispensing unit and the container dispensing unit based on a no-container signal from the container detecting unit.

5. The token dispensing device of claim 4,
further includes a displaying unit for providing indicia,
indicating removal of the container based on the removing signal.

6. The token dispensing device of claim 4, where
the amount detecting unit is a counter which counts tokens dispensed from the token dispensing unit.
